(19) United States
(12) Patent Application Publication
(10) Pub. No.: US 2014/0020802 A1
(43) Pub. Date: Jan. 23, 2014

(54) PNEUMATIC VEHICLE TIRE

(71) Applicant: Continental Reifen Deutschland GmbH, Hannover (DE)

(72) Inventor: Jens Kleffmann, Hannover (DE)

(73) Assignee: Continental Reifen Deutschland GmbH, Hannover (DE)

(21) Appl. No.: 14/034,264

(22) Filed: Sep. 23, 2013

Related U.S. Application Data
(63) Continuation of application No. PCT/EP2012/052167, filed on Feb. 9, 2012.

(30) Foreign Application Priority Data
Mar. 21, 2011 (DE) 10 2011 001 424.1

(51) Int. Cl. B60C 11/01

(52) U.S. Cl. CPC B60C 11/01
USPC 152/209.16

(57) ABSTRACT

A vehicle pneumatic tire for utility vehicles has a tread profile in which a shoulder profile band (19) is formed. The shoulder profile band (19) is bounded by a groove (20) and by a flank surface of the side wall (2) of the tire. The surface which forms the road contact surface is formed in the shoulder profile band (19) in a first extension (21) having a width (a) up to an inflection point (P) as a prolongation of the curved surface contour line (K) and in a second extension (22) of width (b) where b<B starting from the inflection point (P) up to the flank surface side wall (2) in a linear fashion at an angle (α) of inclination with respect to a tangent to the surface contour line (K) at the point (P) where 3°≦α≦25°.

### CROSS REFERENCE TO RELATED APPLICATIONS

This application is a continuation application of international patent application PCT/EP2012/052167, filed Feb. 9, 2012, designating the United States and claiming priority from German application 10 2011 001 424.1, filed Mar. 21, 2011, and the entire content of both applications is incorporated herein by reference.

### FIELD OF THE INVENTION

The invention relates to a pneumatic vehicle tire for commercial vehicles, having a tread profile, which extends in the axial direction A of the pneumatic vehicle tire between two tire shoulders, in each of which a shoulder profile band is formed so as to be extended over the circumference of the pneumatic vehicle tire, the shoulder profile band being bounded toward the equatorial plane Ä of the tire in the axial direction A by a groove extended over the circumference of the pneumatic vehicle tire and, on the side of the band which is remote from the equatorial plane Ä, in each case being bounded by a surface of the tire side wall, the surface forming the flank of the shoulder profile band remote from the equatorial plane, wherein the tread profile is bounded in the section planes containing the tire axis by a surface which forms the road contact surface, which, between the shoulder profile bands, forms a surface contour line that is curved toward the tire.

### BACKGROUND OF THE INVENTION

Pneumatic vehicle tires of this kind for commercial vehicles are known. In the case of tires of this kind, the outer contour line in the cross-sectional planes containing the tire axis in each case forms the intersection line contour of the circumferential surface formed by the radially outwardly directed surfaces bounding the profile ribs or profile block elements of profile block rows. Normally, the outer contour line extends with a continuous slight curvature from the intersection line of one tire side wall of the tire with the radially outwardly directed surface of the shoulder band adjacent to the first tire side wall as far as the intersection line of the other tire side wall with the radially outwardly directed surface of the shoulder band adjacent to the second tire side wall.

There is a known practice, in the case of commercial pneumatic vehicle tires of this kind, of enabling a reduction in the rolling resistance by reducing the profile depth over the entire extent of the tread profile, but this is at the expense of the abrasion properties of the commercial pneumatic vehicle tire.

Another known practice is that of designing only the shoulder profile band with a reduced profile depth over its entire width in the axial direction A of the tire, as compared with the profile bands formed between the shoulder profile bands. As a result, a pronounced jump in the surface contour and the profile depth is formed in the axial region of the extent of the circumferential groove separating the shoulder profile band from the adjacent profile bands. Such complete reductions of the profile depth in the region of the shoulder bands have a negative effect on both the abrasion properties and the rolling resistance.

In order to reduce rolling resistance, German Patent Application DE 10 2009 044 418.1 discloses forming the surface contour of the shoulder band in a first axial region of extent adjoining the separating circumferential groove so as to follow the surface contour line of the tread profile formed between the shoulder bands, as far as a step change in the shoulder band, at which the surface contour changes abruptly and, at the same time, the profile depth is significantly reduced. From this step change with the surface contour formed in a reduced radial position and with a reduced profile depth, the shoulder band is formed so as to extend as far as the side wall in a second axial region of extent of the shoulder band. This embodiment already leads to significant improvements in rolling resistance. Owing to the significant reduction in rubber material due to the removal of material, there is a slight increase in abrasion as a result.

### SUMMARY OF THE INVENTION

It is an object of the invention to provide a pneumatic vehicle tire for commercial vehicles in which both rolling resistance and abrasion and hence the service life of the commercial vehicle tire can be improved by simple means.

According to the invention, this object is achieved by configuring a pneumatic vehicle tire for commercial vehicles, having a tread profile, which extends in the axial direction A of the pneumatic vehicle tire between two tire shoulders, in each of which a shoulder profile band is formed so as to be extended over the circumference of the pneumatic vehicle tire, this shoulder profile band being bounded toward the equatorial plane Ä of the tire in the axial direction A by a groove extended over the circumference of the pneumatic vehicle tire and, on the side of the band which is remote from the equatorial plane, in each case being bounded by a surface of the tire side wall, the surface forming the flank of the shoulder profile band remote from the equatorial plane Ä, wherein the tread profile is bounded in the section planes containing the tire axis by a surface which forms the road contact surface, which, between the shoulder profile bands, forms a surface contour line that is curved toward the tire, wherein, in at least one shoulder profile band of width B, measured in the axial direction A, the surface forming the road contact surface is formed as the prolongation of the curved surface contour line K into the shoulder profile band in an axial first section of extent of width (a) adjoining the circumferential groove, up to a point P of inflection, and, in an axial second section of extent of width (b), where b<B, starting from the point P of inflection up to the side wall, is formed in a linear fashion with an inward slope in radial direction R enclosing an angle α of inclination with respect to the tangent (t) to the surface contour line K at the point P of inflection, where 3°≦α≦25°.

As a result of this configuration, it is possible to improve both the rolling resistance and the abrasion and hence the long-term life of the tire. Surprisingly, tests have shown that it is thereby possible to achieve a further improvement in rolling resistance, even when compared with designs that have shoulder profile bands with abrupt partial reductions of the profile depths.

In use under load, the relatively small, uniform change in the material due to the small angle α of inclination in the outer shoulder band region brings about more uniform load distribution, optimized abrasion properties and, as a result, optimized long-term performance properties of the commercial vehicle tire.

An embodiment of a pneumatic vehicle tire wherein the width (b) of the second axial section of extent is configured to be 8 mm≦b≦60 mm is particularly advantageous. It is thereby possible, in a simple, effective manner, to achieve a further improvement in rolling resistance in conjunction with good abrasion properties. If the width (b) of the second axial section of extent is configured to be 12 mm≦b≦40 mm, particularly good results can be achieved for the rolling resistance in conjunction with good abrasion properties.

An embodiment of a pneumatic vehicle tire wherein the maximum profile depth PT in the circumferential groove is configured to be PT>9 mm is particularly advantageous. In this way, it is possible in a simple manner to achieve the long service life that is customary in the case of commercial vehicle tires.

An embodiment of a pneumatic vehicle tire wherein the profile band is configured as a profile rib is particularly advantageous.

An embodiment of a pneumatic vehicle tire wherein the profile band is configured as a profile block row is particularly advantageous. It is thereby possible to achieve an additional improvement in traction and wet grip properties.

An embodiment of a pneumatic vehicle tire wherein the pneumatic vehicle tire is configured for use on the driven axle of a commercial vehicle is particularly advantageous. It is precisely in this context that the abrasion- and rolling resistance-reducing effect is particularly effective since it is precisely in the case where a pneumatic vehicle tire is used on the driven axle that the driving torques applied to the tread surface are of great significance for the rate of abrasion.

### BRIEF DESCRIPTION OF THE DRAWINGS

The invention will now be described with reference to the drawings wherein:

FIG. 1 shows a cross section of a commercial vehicle tire through the tire axis; and,

FIG. 2 an enlarged detail view of the shoulder section of the commercial vehicle tire of FIG. 1 in a cross section.

### DESCRIPTION OF THE PREFERRED EMBODIMENTS OF THE INVENTION

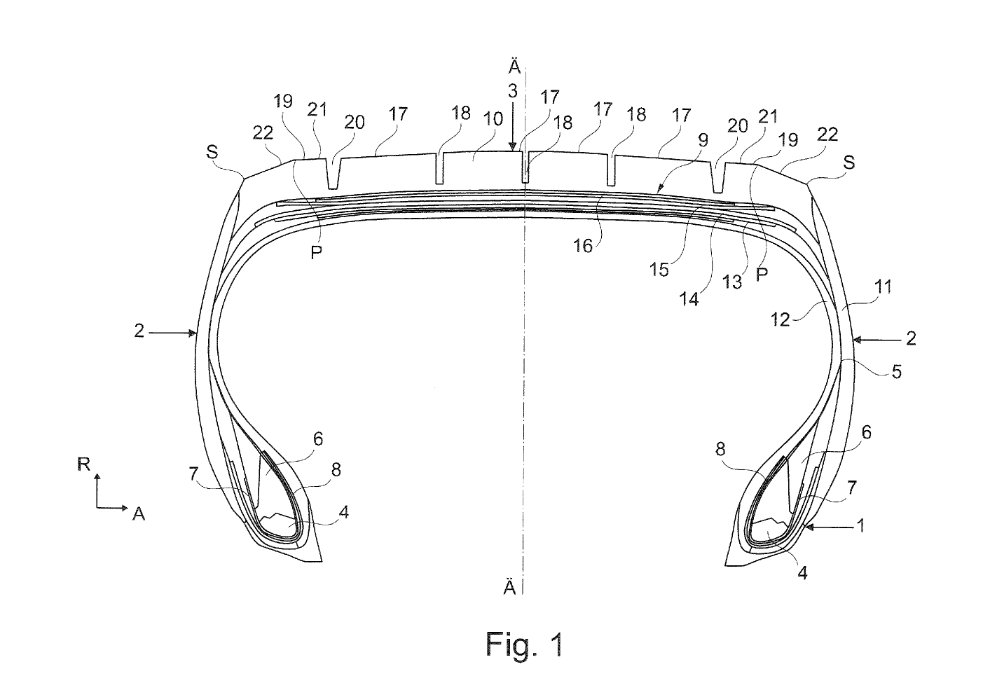

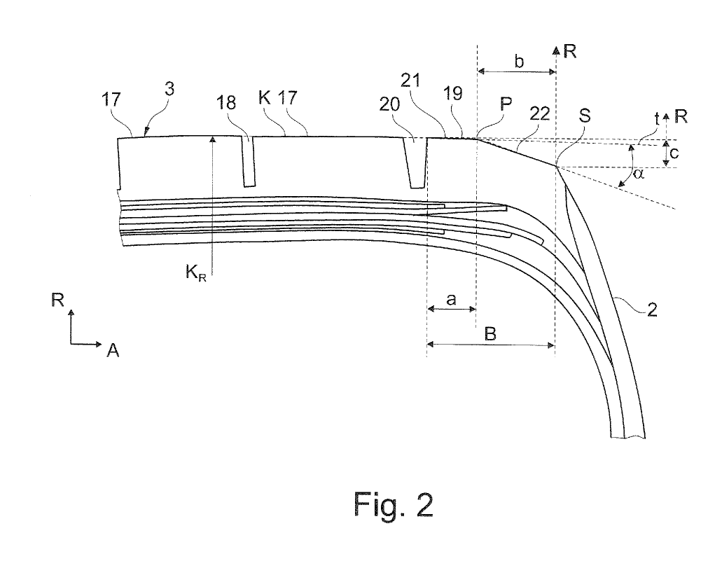

FIGS. 1 and 2 show a commercial pneumatic vehicle tire of radial construction for the driven axle of a commercial vehicle with two side walls 2 extended in the radial direction R of the vehicle tire and a crown region 3 formed axially therebetween. At the radially inward-facing end of the extent of the side walls, the side walls are each formed with a bead region 1. A bead core 4 is formed in the bead region 1 and is of known type resistant to tension in the circumferential direction U and extends in the circumferential direction over the circumference of the tire. The bead cores 4 are formed in a known manner from wound wire embedded in rubber and extended in the circumferential direction U of the pneumatic vehicle tire. An apex (bead filler) 6 of triangular cross section made of hard rubber material is formed in a conventional manner on the bead cores 4. The pneumatic vehicle tire is formed with a carcass 5, which extends outward in the radial direction R of the pneumatic vehicle tire from the bead core 4 formed in the left-hand bead region 1 of the pneumatic vehicle tire, through the left-hand side wall 2, as far as the crown region 3 and, in the crown region 3, extends in the axial direction A of the pneumatic vehicle tire as far as the right-hand side wall 2 and, in the right-hand side wall 2 of the pneumatic vehicle tire, extends radially inward as far as the bead core 4 formed in the bead region 1 of the right-hand side wall 2. In both bead regions 1, the carcass 5 is formed so as to extend in each case along the axial inside of the bead core 4 to the radial inside of the corresponding bead core 4, then, as an extension, in the axial direction along the radial inside of the bead core 4 to the axial outside of the bead core 4 and then, as an extension, radially outward on the axial outside of the bead core 4 as a turned-up part 7. The turned-up part 7 of the carcass 5 extends along the axial outside of the apex 6 and ends on the axial outside of the apex 6. The carcass 5 is formed in a known manner that is not shown specifically by a carcass ply extending over the entire circumference of the pneumatic vehicle tire in the circumferential direction U and including parallel cords—for example steel cords—embedded in rubber which extend substantially in the radial direction R in the region of the side walls 2 and substantially in the axial direction A in the crown region 3. An inner layer 12 of a known rubber material that is particularly impermeable to air extends from the left-hand bead region 1 to the right-hand bead region 1 on the side of the carcass 5 which faces the inside of the tire. An additional bead reinforcing strip 8, which extends over the entire circumference of the pneumatic vehicle tire, is in each case formed in the bead region 1 on the side of the carcass 5 which faces away from the bead core 4. The bead reinforcing strip 8 is, for example, a strip of material consisting of parallel reinforcements of textile or metal construction embedded in rubber.

In the region of the tire crown 3, a belt 9 extending over the entire circumference of the pneumatic vehicle tire in the circumferential direction U and from the left-hand tire shoulder to the right-hand tire shoulder in the axial direction A is formed on the carcass 5, to the outside of the carcass 5, in the radial direction R of the pneumatic vehicle tire, the belt being formed with a known four-ply arrangement by four belt plies 13, 14, 15 and 16 of known type arranged one above the other and one on top of the other in the radial direction R. The belt plies 13, 14, 15 and 16 are each produced in a known manner from steel cords embedded in rubber or other known reinforcements suitable for the production of belt plies of commercial vehicle tires. A profiled tread 10 of known type extending over the entire circumference of the pneumatic vehicle tire in the circumferential direction U and from the left-hand tire shoulder to the right-hand tire shoulder in the axial direction A is formed on the belt 9, radially to the outside of the belt 9, the tread completely covering the belt 9. A rubber side wall strip 11 is formed in a known manner in the region of the tire side walls 2, on the side of the carcass 5 which faces axially away from the tire, the strip extending in the radial direction R from the bead region 1 to the profiled tread 10 in the crown region 3.

In both tire shoulders, the tread profile 3 is formed by a radially raised profile band 19 forming a shoulder band. The two profile bands 19 are extended over the entire circumference of the pneumatic vehicle tire and are formed so as to be aligned in the circumferential direction U of the pneumatic vehicle tire. Toward the equatorial plane Ä of the pneumatic vehicle tire, the profile band 19 is in each case bounded by a circumferential groove 20 extended over the entire circumference of the pneumatic vehicle tire and aligned in the circumferential direction U. The tread profile 3, consisting of a plurality of profile bands 17 arranged adjacent to one another in the axial direction A of the pneumatic vehicle tire, each extended over the entire circumference of the pneumatic vehicle tire and aligned in the circumferential direction, is formed between the two circumferential grooves 20. Adjacent profile bands 17 of this central region of extent formed between the circumferential grooves 20 are each spaced apart from one another, in each case in the axial direction A of the pneumatic vehicle tire, by a circumferential groove 18, which extends over the entire circumference of the pneumatic vehicle tire and is aligned in the circumferential direction. In the illustrative embodiment shown in FIG. 1, four profile bands 17, which form the central region of extent, are formed between the two circumferential grooves 20 separating the respective shoulder region from the central section of extent of the tread profile 3.

In this case, the circumferential groove 20, in each case by means of its groove wall directed toward the adjoining profile band 19, forms the flank of the profile band 19 which delimits the profile band 19 with respect to the equatorial plane Ä.

The extension of the axially outward-facing surface of the tire side wall 2 of the pneumatic vehicle tire, the side wall being shown on the left-hand side in FIG. 1, forms that flank of the profile band 19 which delimits the profile band 19 formed in the left-hand tire shoulder with respect to the side facing away from the equatorial plane Ä, and extends as far as the surface which delimits the profile band 19 on the outside in the radial direction, which intersects at the point of intersection S in the cross-sectional planes containing the tire axis.

The radial extension of the axially outward-facing surface of the tire side wall 2 illustrated on the right-hand side in FIG. 1 likewise forms that flank of the profile band 19 which delimits the profile band 19 formed in the right-hand tire shoulder with respect to the side facing away from the equatorial plane Ä, and extends as far as the surface which delimits the profile band 19 on the outside in the radial direction, which intersects at the point S of intersection in the cross-sectional planes containing the tire axis.

The profile bands 17 of the central region of extent between the circumferential grooves 20 are delimited toward the outside in the radial direction by the radially outer surface thereof which forms the road contact surface, which, in the extension thereof across the circumferential grooves 18, forms the surface contour line K between the circumferential grooves 20 as part of the circumferential surface of the tread profile in the cross-sectional planes containing the tire axis. In a first axial region 21 of extent of the width (a) of extent, measured in the axial direction A in the cross-sectional planes containing the tire axis, the region in each case directly adjoining the circumferential groove 20, that surface of the profile bands 19 which points outward in the radial direction R of the tire is in each case formed with its outer contour line as an extension of the surface contour line K of the central section of extent across the circumferential groove 20, as far as a point P of inflection, which is formed at the distance (a) from the circumferential groove 20.

Between the point P of inflection of the right-hand tire shoulder and the point S of intersection of the left-hand tire shoulder, the surface contour line K is formed so as to curve with a continuous slight curvature with a radius KR of curvature toward the interior of the tire.

From the point P of inflection, the radially outer surface of the profile band 19 is formed so as to extend in a second axial region 22 of extent up to the point S of intersection in a straight line enclosing an angle a of inclination with respect to the tangent formed to the surface contour line K of region 21 of extent.

This second region 22 of extent extends over a width (b) of extent, measured in the axial direction A, between the point P of inflection and the point S of intersection of the profile band 19.

In this case, as can be seen in FIG. 2, the surface contour line of the radially outer surface is formed axially outward as far as point S of intersection in region 22 of extent, while sloping radially inward, starting from the point P of inflection, that is, the radial position of the surface contour line in region 22 of extent falls continuously from point P to point S of the profile band 19.

As can be seen in FIGS. 1 and 2, the belt 9 of the pneumatic vehicle tire extends in an axial direction into the axial region of extent, of width B, of the radially outer surface of the respective profile band 19 and ends there.

The angle α of inclination is configured to be 3°≦α≦25°. A design with an angle of inclination of 5°≦α≦15° is particularly effective. In the illustrative embodiment shown, α=11° has been selected.

The width B of extent is configured to be B=(a+b), where a>0 mm and where b<B.

The length (b) of extent is configured to be 8 mm≦b≦60 mm. It has proven particularly advantageous to make the length (b) of extent 12 mm ≦b≦40 mm. For conventional tire sizes for commercial vehicles, it is particularly appropriate and effective to make (b) 15 mm b≦b≦25 mm.

It has proven particularly advantageous to make the length (a) of extent a≧5 mm.

As shown in FIG. 2, the point S of intersection is formed radially to the inside of the position of the point P of inflection, at a distance (c), measured in the radial direction R, from the point P of inflection.

In the illustrative embodiment shown, α=11°, b=20 mm and c=4 mm.

The profile bands 17 of the central region of extent are configured as circumferential ribs or as circumferential profile block rows including profile block elements arranged one behind the other over the circumference of the pneumatic vehicle tire and separated from one another by respective transverse grooves. In one embodiment, all the profile bands 17 are configured as profile ribs. In another embodiment, all the profile bands 17 are configured as profile block rows. In another embodiment, only some of the profile bands 17 are configured as profile ribs and the other profile bands 17 are configured as profile block rows.

In one embodiment, the shoulder profile bands 19 are configured as circumferential ribs which extend over the entire circumference of the pneumatic vehicle tire. In another embodiment, the shoulder profile bands 19 are configured as shoulder profile block rows with profile block elements arranged one behind the other in the circumferential direction of the pneumatic vehicle tire and spaced apart by respective transverse grooves. In another embodiment, one shoulder profile band 19 is configured as a profile rib and the other shoulder profile band is configured as a shoulder profile block row.

In one embodiment, the shoulder profile bands 19 are provided at least in part with sipes on their surface that faces outward in the radial direction R.

The maximum profile depth PT in the circumferential groove 20 is configured to be PT>9 mm.

It is understood that the foregoing description is that of the preferred embodiments of the invention and that various changes and modifications may be made thereto without departing from the spirit and scope of the invention as defined in the appended claims.

### LIST OF REFERENCE NUMERALS

### Part of the Description

1 bead region
2 side wall
3 crown region
4 bead core
5 carcass
6 apex (bead filler)
7 carcass turn-up
8 bead reinforcing strip
9 belt
10 profiled tread
11 rubber side wall strip
12 inner layer
13 belt ply
14 belt ply
15 belt ply
16 belt ply
17 profile band
18 circumferential groove
19 shoulder profile band
20 circumferential groove
21 first region of extent
22 second region of extent

What is claimed is:

1. A pneumatic vehicle tire defining a tire axis, an axial direction A, a equatorial plane and a tire circumference, the pneumatic vehicle tire comprising:
a first tire shoulder;
a second tire shoulder;
a tread profile extending in the axial direction (A) between said first and said second tire shoulder;
said tread profile having a first shoulder profile band extending in said first tire shoulder over the circumference of the pneumatic vehicle tire;
said tread profile having a second shoulder profile band extending in said second tire shoulder over the circumference of the pneumatic vehicle tire;
said tread profile defining a first groove which extends over the tire circumference and delimits said first shoulder profile band in the direction of the equatorial plane;
said tread profile defining a second groove which extends over the tire circumference and delimits said second shoulder profile band in the direction of the equatorial plane;
a first tire side wall having a first flank surface which delimits said first shoulder profile in the direction away from the equatorial plane;
a second tire side wall having a second flank surface which delimits said second shoulder profile in the direction away from the equatorial plane;
said tread profile defining a plurality of cross-sectional planes which include the tire axis;
said tread profile having a road contact surface which delimits said tread profile in each of said cross-sectional planes;
said road contact surface having a curved surface contour line (K) between said first shoulder profile band and said second shoulder profile band;
at least one of said shoulder profile bands having a width (B) measured in said axial direction (A) and defining an inflection point (P) within said width (B);
said width (B) including a first axial extension having a width (a) extending from the groove corresponding to said one shoulder profile band to said inflection point (P);
said width (B) including a second axial extension having a width (b) extending from said inflection point (P) to the one of said flank surfaces corresponding to said one shoulder profile band wherein said width (b) is less than said width (B); and,
said road contact surface being configured in said one shoulder profile band as an extension of said curved contour surface line (K) up to said inflection point (P) and from said inflection point (P) in said second axial extension up to said one flank surface in a straight line directed inwardly in radial direction (R) at an inclination angle (α) to a tangent (t) formed on said surface contour line (K) at said inflection point (P) and wherein said angle (α) lies in a range of 3°≦α≦25°.

2. The pneumatic vehicle tire of claim 1, wherein said width (b) of said second axial extension lies in the range of 8 mm≦b≦60 mm.

3. The pneumatic vehicle tire of claim 1, wherein said width (b) of said second axial extension lies in the range of 12 mm≦b≦40 mm.

4. The pneumatic vehicle tire of claim 1, wherein said first and said second grooves each have a profile depth (P_{T}) where P_{T}>9 mm.

5. The pneumatic vehicle tire of claim 1, wherein at least one of said first and said second shoulder profile bands is configured as a profile rib.

6. The pneumatic vehicle tire of claim 1, wherein at least one of said first and said second shoulder profile bands is configured as a profile block row.

7. The pneumatic vehicle tire of claim 1, wherein the tire is configured for use on a drive axle of an utility vehicle.
